(19) United States
(12) Patent Application Publication
(10) Pub. No.: US 2010/0125560 A1
(43) Pub. Date: May 20, 2010

(54) Uncertainty-based geocoding for risk management

(76) Inventors: Michael Asher, Green Cove Springs, FL (US); Harold Jeffrey Stewart, Cumming, GA (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/313,118

(22) Filed: Nov. 17, 2008

(51) Int. Cl. G06F 17/30

(52) U.S. Cl. 707/706; 707/E17.014; 707/E17.018; 707/736

(57) ABSTRACT

System frameworks and methods are described that convert textual location data into physical location data and perform precise operations upon the results regardless of the uncertainty inherent within the data. Embodiments may yield one or more location candidate and per-candidate uncertainty data is natively preserved in a manner which allows precise statements to be made against the imprecise location data. The data representation of the geocoding result is not a single latitude-longitude coordinate, but one or more polygons or a polypolygon.

### BACKGROUND OF THE INVENTION

The invention relates generally to risk management operating methods. More specifically, the invention relates to systems and methods that convert textual location data into physical location data and perform precise operations upon the results regardless of the uncertainty inherent within the data.

Geocoding is the process of assigning geographic identifiers such as codes or geographic coordinates (latitude-longitude) to map features and other data records such as street addresses. Media can also be geocoded, for example, where a picture was taken, Internet Protocol (IP) addresses, and anything that has a geographic component. With geographic coordinates, the features may be mapped and entered into a Geographic Information System (GIS). A geocoder is a hardware and/or software device that performs this process.

One geocoding method used by many systems is address interpolation. This method makes use of data from a street GIS where the street network is already mapped within the geographic coordinate space. Each street segment is attributed with address ranges (house numbers from one segment to the next). Geocoding takes an address and matches it to a street and specific segment such as a block in towns that use the block convention. Geocoding then interpolates the position of the address within the range along the segment.

However, this process is not always straightforward. Difficulties arise when distinguishing between ambiguous addresses such as 151 Elm Street and 151 W. Elm Street, or geocoding new addresses for a street that has not been added to the GIS database. Human error adds to the difficulty when a street name is incorrectly entered or partially given. Asking for the city name, state, province, country, etc., may solve this problem. For example, there are multiple 100 Washington Streets in Boston, Mass., because several cities have been annexed without changing street names.

The typical attribution of a street segment assumes that all even numbered parcels are on one side of the segment, and all odd numbered parcels are on the other. This is often not true. Interpolation assumes that the given parcels are evenly distributed along the length of the segment. It is not uncommon for a geocoded address to be off by several thousand feet. Segment information includes a maximum upper bound for addresses and is interpolated as though the full address range is used. For example, a segment (block) might have a listed range of 100-199, but the last address at the end of the block is 110. In this case, address 110 would be geocoded to 10% of the distance down the segment rather than near the end. Additionally, interpolation error increases as address density decreases. Rural areas typically have larger interpolation errors than urban areas.

Most interpolation implementations will produce a point as their resulting address location. In reality, the physical address is distributed along the length of the segment. Consider geocoding the address of a shopping mall. The physical lot may run some distance along a street segment. In this instance, it may be thought of as a two-dimensional space filling polygon which may front on several different streets. For cities with multi-level streets, a three-dimensional shape that meets different streets at several different levels may be formed but the interpolation treats it as a singularity.

In view of the above, geocoding involves a certain degree of uncertainty since location data has a varying degree of accuracy. However, for risk management, rather than define a location precisely for a data record, the need may be to precisely define where the location is not. For example, whether an insured home lies outside of a predefined high-crime area. Current geocoding implementations treat such exclusionary queries as simply the negative of an inclusionary query, rather than optimizing the geocoding process particularly for such tests.

Today, geocoding is treated as a black box, separate from any operations performed on its results. If an insurance query was performed on whether a particular home was located in a high-crime area, the house address would be input to a geocoder, and the geocoder, using one of a plurality of methods, would produce a latitude-longitude result. The latitude-longitude in turn would be input as a GIS query to compare it geometrically to a set of known high-crime areas.

Even where there is one possible match for a given street address, there is uncertainty as to exactly where that one location is. The location of a street address, 151 Elm Street, is the latitude-longitude location of the mailbox which for some houses may be hundreds of feet from the actual residence. Even the location of the mailbox is subject to uncertainty. No existing street-level database has actual coordinates for every address. Most work off of Address Block Ranges (ABRs). For example, 151 Elm Street may have an ABR from address 100 to address 200. The location of only the endpoints is saved. If the address 151 Elm Street is input, the latitude-longitude coordinates are interpolated to be halfway between the ABR endpoints. Interpolation is only accurate when houses are equally spaced within a block.

Since geocoding involves uncertainty, a geocoder result coalesces all of the uncertainty from many possible location candidates into a single result. For cases where the street address is only partially specified, or multiple streets with the same name exist, there may be many location candidates for where that address actually is.

Geocoding yields all uncertainty as a single most-likely location for further processing. All intermediate information as to other candidates, such as uncertainty in ABR interpolation and other factors is lost. The geocoded location for 151 Elm Street may be 85% reliable, indicating that there is a 15% chance any query performed on its location will be incorrect.

The challenge is to arrive with 100% certainty that a given address lies outside of a query range, regardless of the uncertainty within in the geocoding process.

### SUMMARY OF THE INVENTION

The inventors have discovered that it would be desirable to have system frameworks and methods that that convert textual location data into physical location data and perform precise operations upon the results regardless of the uncertainty inherent within the data. Embodiments may yield one or more location candidate and per-candidate uncertainty data is natively preserved in a manner which allows precise statements to be made against the imprecise location data. The data representation of the geocoding result is not a single latitude-longitude coordinate, but one or more polygons or a polypolygon.

For cases where it is desirable to exclude locations from a following GIS query, embodiments can determine whether or not a location, such as a construction activity, is within a predetermined location, such as a buried cable or pipeline.

One aspect of the invention provides a method for converting location data into one or more physical locations. Methods according to this aspect of the invention include inputting the location data, accessing a Geographic Information System (GIS) library, performing geocoding for the location data, determining one or more location candidate for the location data, and generating a polygon for each location candidate.

Another aspect of the invention is a method for comparing at least one location candidate based on converted location data with a predefined area. Methods according to this aspect of the invention include inputting a predefined area, accessing one or more location candidate, generating a polygon for each location candidate, comparing the one or more location candidate polygons with the predefined area, and determining if the one or more location candidate polygons are outside of the predefined area.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary system framework.

FIG. 2 is an exemplary method.

FIG. 3 is an exemplary result showing a polypolygon.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of alternative software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

Embodiments of the invention provide methods, system frameworks, and a computer-usable medium storing computer-readable instructions for configuring one or more computers. The invention may be enabled as a modular framework and/or deployed as software as an application program tangibly embodied on a program storage device. The application code for execution can reside on a plurality of different types of computer readable media known to those skilled in the art.

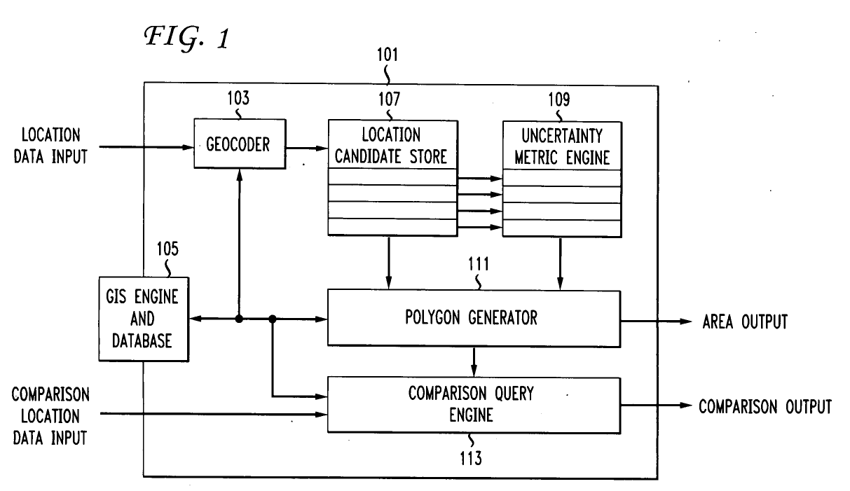

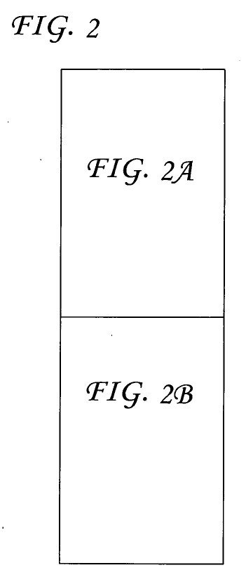

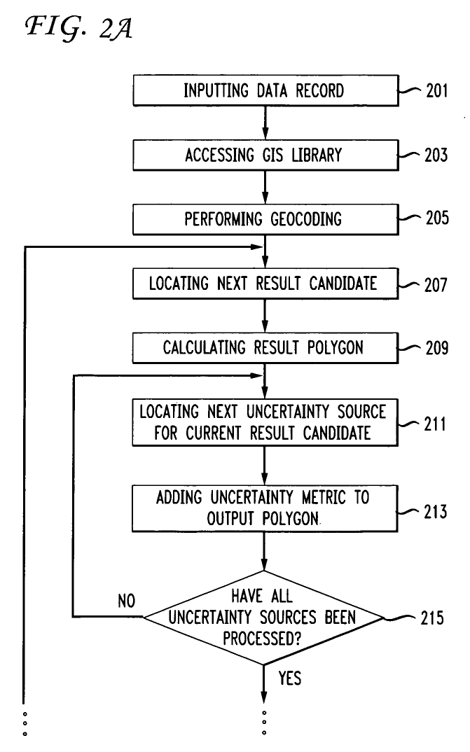

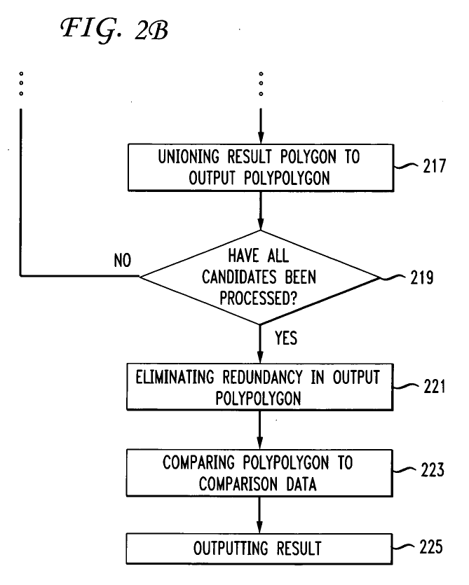

FIG. 1 shows an embodiment of a system framework 101 and FIG. 2 shows a method. The framework 101 includes a geocoder 103 configured to receive location data. The geocoder 103 is coupled to a GIS database 105 and a location candidate store 107.

The candidate store 107 stores one or more candidate location output from the geocoder 103. The candidate store 107 is coupled to an uncertainty metric engine 109 configured to calculate an uncertainty metric for each location candidate output by the geocoder 103. The candidate store 107 and uncertainty metric engine 109 are coupled to a polygon generator 111 configured to generate a polygon encompassing a location candidate in conjunction with GIS data 105. A polygon/polypolygon result may be output (area output). The polygon generator 111 is coupled to a comparison query engine 113. If a comparison of the polygon/polypolygon result with a geographic area of interest is desired, the comparison data is input and a comparison result may be output (comparison output).

The framework 101 may be implemented as a computer including a processor, memory, storage devices, software and other components. The processor is coupled to I/O, storage and memory and controls the overall operation of the computer by executing instructions defining the configuration. The instructions may be stored in the storage device, for example, a magnetic disk, and loaded into the memory when executing the configuration. The invention may be implemented as an application defined by the computer program instructions stored in the memory and/or storage and controlled by the processor executing the computer program instructions. The I/O allows for user interaction with the computer via peripheral devices such as a display, a keyboard, a pointing device, and others.

Geocoders output a latitude-longitude for location data input using a series of tests. A location is typically input via a Man Machine Interface (MMI) and the geocoder generates all possible location candidates. A selection is performed based upon the most likely candidate from one or more returned results. If a location candidate is a block or other area feature, the candidate is located at the most likely location within a polygon. If a new candidate is better than the best candidate from any previous test, it is selected as the most likely. All of the steps are repeated until all geocoding tests are completed. The geocoder then outputs a latitude-longitude result for the input location.

Embodiments are not directed to one particular method of geocoding, but to an adjustment which may be applied to any prior art geocoder. Embodiments of the invention store the uncertainty at each step during the geocoding process by which multiple location candidates 107 and per-candidate uncertainty data 109 for an input location is natively preserved. The exact uncertainty data available to the geocoder 103 is also available to the upper-level method which uses the results of the geocoding. This is opposed to prior art geocoders which output a latitude-longitude location plus an uncertainty measurement such as 85% accurate or accurate to within 50 meters. The uncertainty data 109 allows precise statements to be made against imprecise location data. The data representation of the geocoding result is not a single latitude-longitude coordinate, but one or more polygons. If more than one location candidate results, forming more than one candidate polygon, a polypolygon from the candidate polygons is generated. A polypolygon is a set of closed polygons.

In the method, location data such as an address, 123 Main Street, Anywhere, NY, is input to the framework 101 (step 201) where it is matched against a GIS street address database/library 105 (step 203). Geocoding is performed using look-up heuristics (step 205) and resolved into one or more location candidates (step 207). For each location candidate, a location candidate latitude-longitude coordinate is stored 107 and a polygon is generated (step 209). Each location candidate may have one or more associated uncertainty 109 (step 211) and a metric for each uncertainty is calculated and added to the generated polygon for that location candidate (step 213).

In one embodiment, the uncertainty metric may be calculated as a function of the distance the numeric street address lies from the endpoint of an ABR and is a sum of all uncertainties generated or calculated by the method. Latitude-longitude coordinates are interpolated from the location of the address within an ABR, resulting in an interpolation error. There is an additional error based on the ABR location method itself, for example, GPS, initial survey reference point, and other inaccuracies. The summation of all error bars for that location candidate is calculated (step 215).

One address may yield multiple location candidates. For 123 Main Street, there may exist 123 Main Street East along with 123 Main Street West. This results in two candidates, each having a determined uncertainty metric. Another example may be where the given street name may exist with multiple spellings or the given numeric address may not exist on that particular street. The geocoder 103 may return a Minimum Bounding Rectangle (MBR) bounding the entire length of the street rather than a single latitude-longitude. An MBR is the smallest area in which the actual location must lie. Another example may be where the city name may exist multiple times in the given state, or might be a blanket designation for a large metropolitan area containing dozens of actual suburbs/townships. For example, Atlanta, Ga., may refer to any one of two dozen U.S. Postal Service city names. In yet another example, the given street address may be supplanted by non-street information, such as a grid location, nearest intersection, township block, suburb name, or other data.

Each of the above may yield one or more location candidates (step 207), with each location candidate geocoded to uncertainty-based latitude-longitudes or MBRs. The MBR or an exact polygon encapsulates the sum total of the uncertainty in that particular location's candidate (step 217).

After all uncertainties for a candidate have been considered (step 219), a next candidate result is processed (steps 207, 209, 211, 213, 215, 217). Any redundant overlap between polygons for the given address may be removed and does not affect the underlying method (step 221). The result may be output (area output) as a polygon or polypolygon object.

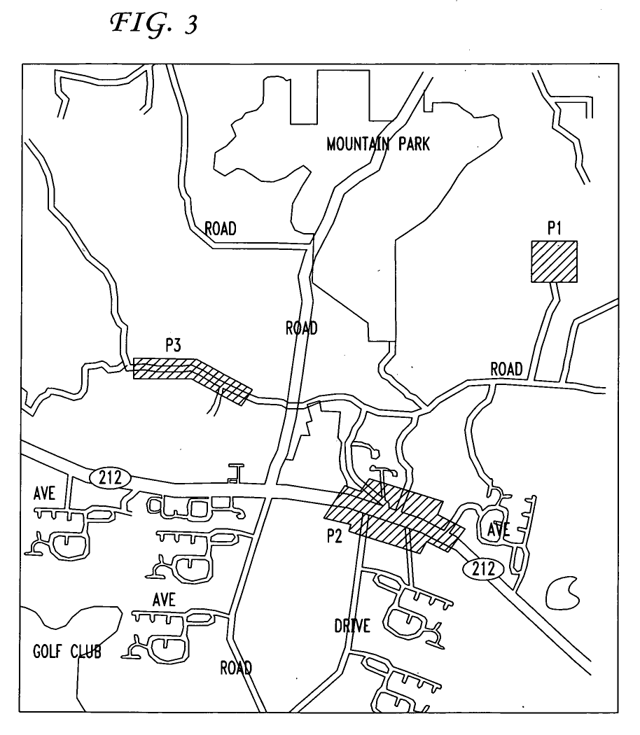

FIG. 3 shows a result. Polypolygons are figures assembled from other polygons and may be a set of overlapping, but in most circumstances, disconnected polygons. FIG. 3 shows a polypolygon comprised of a first location candidate polygon P1, along with a second location candidate polygon P2 enclosing a street three miles from P1, followed by a third location candidate polygon P3 two miles from P1. All of the location candidate polygons in the exemplary resultant polypolygon are independent and disconnected.

The result (output 1) may be one or more polygons (FIG. 3) which cumulatively represent the potential locations of the location data. Rather than reducing the set of one or more polygons to a single point or object, geometric operations may be performed on the polypolygon natively. The output polypolygon comprises a set of location candidates (P1, P2, P3), each containing its resultant positional and/or estimation uncertainties. The polygon or polypolygon may then be considered as all possible locations for the input address.

For GIS queries that wish to test for exclusion, operations on a polypolygon provide the ability to make statements with total certainty, regardless of the uncertainty within the process. A polypolygon object can then be considered as the geographical sum of all possible locations for the input address.

A geometric intersection test may be performed on the polypolygon (steps 223, 225). For example, the returned polypolygon may be set against one or more high-crime areas. A negative result may indicate the location does not lie within any of the defined areas. The imprecise nature of the source data has not prevented a fully precise statement to be made about its location.

A score of how likely each polygon is may be derived. Embodiments may be used for exclusionary queries and inclusionary queries. For example, the geocoder 103 may return only one location for 151 Elm Street. It may output a certainty score of 85% (or similar analogue) of how likely that match is, but not the other 15%. The inclusionary operating mode operates with an improved degree of accuracy.

The comparison tests may operate off location data other than street addresses. For example, if a complete address record was input and the address portion 151 Elm Street was not found, the geocoder 103 may use the postal code or telephone exchange (the 3 digits following the area code), to add the respective areas for each to the output polypolygon. Even where the street address is not in the GIS database 105, the method outputs with 100% certainty that the respective location does not match the input query.

The framework 101 and method tests each polygon and efficiently determines the likelihood of a match being correct. A standard geographic query may be performed against the polypolygon. If successful, each individual polygon within its parent is retested, and the uncertainty score associated with that polygon is retrieved. The normal exclusionary mode does not require any subtests. In the inclusionary mode, one may test the individual polygons within the set to further quantify the error.

Public data libraries are available for geometric operations upon polypolygons. The method allows for their direct use on imprecise location data. The representation also allows the preservation of the degree of uncertainty within the geocoding operation, providing substantial advantages over current implementations.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for converting location data into one or more physical locations comprising:
inputting the location data;
accessing a Geographic Information System (GIS) library;
performing geocoding for the location data;
determining one or more location candidate for the location data; and
generating a polygon for each location candidate.

2. The method according to claim 1 further comprising for each location candidate, calculating one or more uncertainty metric.

3. The method according to claim 2 further comprising storing the one or more uncertainty metric.

4. The method according to claim 3 further comprising for each location candidate, summing the one or more uncertainty metric and including the sum in the location candidate polygon.

5. The method according to claim 1 further comprising if there is more than one candidate polygon generated, generating a polypolygon.

6. The method according to claim 5 further comprising removing any overlap among the candidate polygons in the polypolygon

7. The method according to claim 1 further comprising:
comparing the one or more location candidate polygons with one or more predefined areas; and
indicating whether the one or more location candidate polygons are outside of the one or more predefined areas.

8. The method according to claim 7 wherein comparing further comprises performing a geometric intersection test.

9. A method for comparing at least one location candidate based on location data with a predefined area comprising:
inputting a predefined area;
accessing one or more location candidate;
generating a polygon for each location candidate;
comparing the one or more location candidate polygons with the predefined area; and
determining if the one or more location candidate polygons are outside of the predefined area.

10. The method according to claim 9 further comprising for each location candidate, calculating one or more uncertainty metric.

11. The method according to claim 10 further comprising storing the one or more uncertainty metric.

12. The method according to claim 11 further comprising for each location candidate, summing the one or more uncertainty metric and including the sum in the location candidate polygon.

13. The method according to claim 9 further comprising if there is more than one candidate polygon generated, removing any overlap among the candidate polygons.

14. The method according to claim 13 wherein comparing further comprises performing a geometric intersection test.
